(19) United States
(12) Patent Application Publication
(10) Pub. No.: US 2012/0174867 A1
(43) Pub. Date: Jul. 12, 2012

(54) WILDLIFE FEEDING BLOCK

(76) Inventor: James W. Campbell, Akron, NY (US)

(21) Appl. No.: 13/341,907

(22) Filed: Dec. 31, 2011

Related U.S. Application Data
(60) Provisional application No. 61/460,382, filed on Dec. 31, 2010.

(51) Int. Cl. A01K 5/00

(52) U.S. Cl. 119/51.03

(57) ABSTRACT

A wildlife feeding block especially suitable for feeding deer is in the form of a log of generally cylindrical shape containing a composite of meal, corn, molasses, a preservative, an attractant, and a binder. The log has a pair of grooves disposed diametrically opposite to each other and extending the length of the log, the grooves are generally semi-circular in cross-section so as to enable the deer to feed on the log by inserting its snout into the grooves and biting off pieces of the log.

Priority is claimed to U.S. Provisional Patent Application Ser. No. 61/460,382, filed Dec. 31, 2010, which is incorporated herein by reference.

### DESCRIPTION

The present invention relates to wildlife feeding blocks or cakes and particularly to deer logs shaped so as to enable a deer to place its snout (at least the front part thereof) into a curved section of the log to facilitate the deer's feeding on the contents of the log.

While various blocks or cakes have been proposed as wildlife and animal feed devices as for example described in the following U.S. Patents: Lush et al., U.S. Pat. No. 5,855,943, issued Jan. 5, 1999; Weil, U.S. Pat. No. 1,009,361, issued Nov. 21, 1911; Aniser, U.S. Pat. No. 2,908,250, issued Oct. 13, 1959; Patten, U.S. Pat. No. 2,139,910, issued Dec. 13, 1938; Molitorisz, U.S. Pat. No. 3,357,835, issued Dec. 12, 1967; Mendes et al., U.S. Pat. No. D528,261, issued Sep. 19, 2006; Mendes et al., U.S. Pat. No. D538,506, issued Mar. 20, 2007; Unlu et al., U.S. Pat. No. D516,276, issued Mar. 7, 2006; Turner, U.S. Pat. No. D501,700, issued Feb. 15, 2005; Englisch, U.S. Pat. No. D512,810, issued Dec. 20, 2005; Bazzaro et al., U.S. Pat. No. 6,344,224, issued Feb. 5, 2002; and Schneider, U.S. Pat. No. 5,052,342, issued Oct. 1, 1991. None of such devices are especially suitable for attracting and feeding deer. Deer snouts are designed for biting and severing grasses and leaves, rather than blocks and cakes of the shape which have been previously proposed such as are described in the above-identified patents.

It is the principal feature of the present invention to provide a wildlife feeding block or cake which is in the shape of a log, especially adapted to receive the snout of deer so as to enable the deer to readily bite and feed on the deer log so provided.

Briefly described, the present invention embodies a wildlife feeding block or cake, called herein a deer log, having a body that is generally cylindrical in shape and composed of grains and meal together with preservatives and attractants which are compressed into the shape of a log. The body has a groove, preferably diametrically opposed grooves, of cross-sectional shape which enables the deer to insert the front of their snouts into the log for biting the log and feeding on the material thereof.

The log may be formed with a hole running the length of the log through which a stake, and especially an arrow, may be inserted for holding the log with its longitudinal axis generally perpendicular to the ground as in a clearing where feeding of the deer is desired. The hole may also enable the log to be inserted into a branch or hung by a wire rope or the like above the ground for feeding. Inasmuch as the deer can use the log much like material (grasses or leaves) on which the deer ordinarily feeds, the log is highly attractive to the deer and feeding on the log is therefore encouraged.

The present invention also provides a method for providing a wildlife feeding block having the steps of forming a log shaped body of compressed materials having at least wildlife feed, providing one or more grooves extending longitudinally along the body having a cross-sectional shape compatible with a portion of a deer snout having teeth. The method may further have the step of providing a hole extending longitudinally (or at least partially) through the body. Such hole may be used for mounting the wildlife feeding block in an outdoor environment at a location enabling deer to access the log and feed thereupon. Preferably, two of the grooves are provided along opposite sides of the body.

The foregoing and other objects, features and advantages of the invention will become more apparent from a reading of the following description in connection with the accompanying drawings wherein:

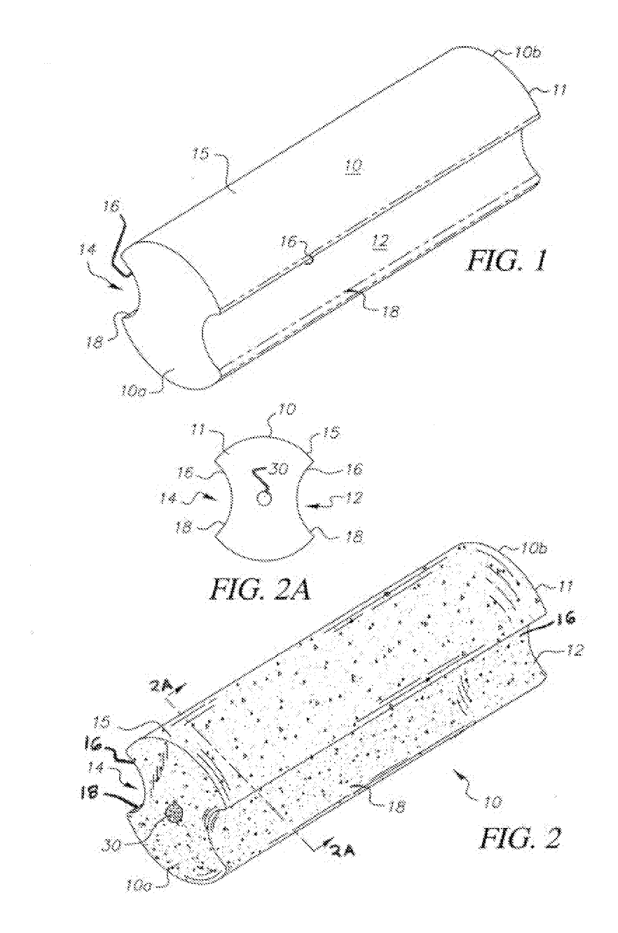

FIG. 1 is a perspective view of a deer log provided in accordance with the invention;

FIG. 2 is a view similar to FIG. 1 showing the deer log showing the curvature of the body of the log in more detail;

FIG. 2A is a cross-sectional view of the deer log taken along the line 2A-2A of FIG. 2;

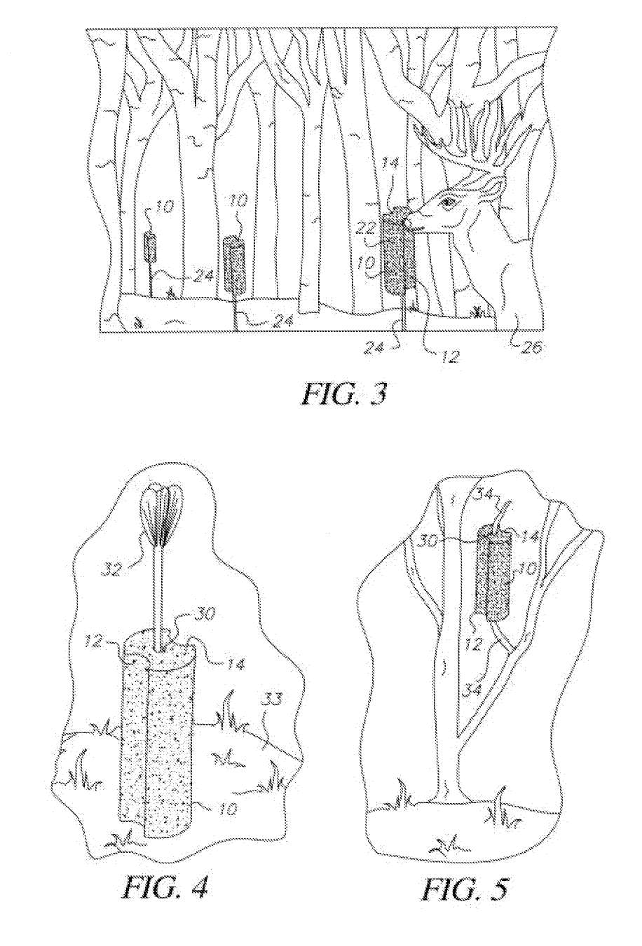

FIG. 3 is an illustration showing a deer adjacent the deer log of the shape shown in FIGS. 1 and 2 in which the deer log is mounted on a stake;

FIG. 4 is a view showing an example of a deer log of the shape shown in FIGS. 1 and 2 which is mounted vertically on an arrow through a hole running the length of the log; and

FIG. 5 is an illustration of a deer log of the shape shown in FIGS. 1 and 2 which is mounted on a branch of a tree via a hole that extends through the central hole in the log.

Referring to FIG. 1, the exemplary deer log 10 has a generally cylindrical body 11 and may have a longitudinal hole (or opening) 30 through the center thereof which is not shown in FIG. 1, but shown in FIGS. 2 and 2A. Diametrically opposite to each other and running longitudinally of the log 10 are grooves 12 and 14 which are each generally semi-circular in cross-section and blend into the surfaces of the log adjacent thereto by two curved sections 16 and 18. The curvature of sections 16 and 18 which meet along the bottom of each of groove 12 and 14 matches (at least substantially) the cross-sectional curvature of the teeth of an adult deer so that the teeth can readily fit into the log 10 so as to facilitate deer feeding on the log. Grooves 12 and 14 may mirror each other along opposite sides of body 11, as shown in FIG. 1.

FIG. 2 shows the log 10 of the same shape as log 10 in FIG. 1. Log body 11 has an external surface 15 which may be granular (or uneven) in texture as a result of the one or more kinds of wildlife feed forming body 11 (see also for example, FIGS. 3-5). The smoothness of external surface(s) 15 along log ends 10a and 10b, the right and left log sides having grooves 12 and 14, respectively, and the log's top and bottom (with respect to the log's orientation of FIGS. 1, 2 and 2A) depends on the composition of materials which body 11 is formed. The internal surface of hole 30 through body 11 may be of the same texture as external surface 15.

FIG. 2A shows the preferred cross-sectional shape of grooves 12 and 14, i.e., generally semi-circular or concave, so as to be compatible with the front part of a deer snout having its teeth to facilitate a deer to readily bite and feed on the deer log 10. Other cross-sectional shape may also be used, if desired, into which the front part of a deer snout can extend into. Two grooves 12 and 14 are preferred in log shaped feed device 10, but one, two, or more than two grooves (or channel(s) or inward concave shaped feature(s)), as desired, extending between the opposite ends 10a and 10b of body 11 may be provided, which facilitate feeding by wildlife. Less preferably, grooves 12 and 14 extend less than the entire length of body 11.

In FIG. 3, the deer log 10 of the shape shown in FIGS. 1 and 2 is indicated at 22 mounted on a stake (or pole) 24. A deer 26 is shown with its snout inserted into groove 12 of the log 10 to feed on the log. This is enabled by the groove having a cross-sectional shape enabling full insertion of a front portion of an adult deer's snout into the groove. Stake 24 may be larger is cross-sectional size than hole 30 so that the top end of the stake frictionally engage hole 30 when located in hole 30 so that the log 10 can be supported at a desired height when the bottom end of the stake is position in the ground or other surface. Optionally, the top end of stake 24 may be driven in log 10 (with or without hole 30 first being formed) partially or through log 10. A plurality of deer logs 10 may be mounted on stakes 24 in vicinity to each other, as shown in FIG. 3. Although the log 10 is intended to be feed by the deer along grooves 12 and 14, the log also has the benefit of enabling the deer to feed upon other parts of the log 10 as desired.

FIG. 4 illustrates the log 10 having through hole 30 through which an arrow 32 extends for holding the log 10 vertical on the ground 33 thereby supporting the log in position for deer feeding. The longitudinal axis of log 10 that extending along hole 30 may thus be generally or substantially perpendicular to ground 33.

FIG. 5 illustrates the log 10 mounted via its hole 30 on a branch 34 of a tree so as to present itself for feeding by deer. The log may be similarly mounted on a bush, and the branch of the tree or bush supporting log 10 may extend through hole (as shown) or partially there through. Thus, as shown in FIGS. 3-5, the log 10 can be positioned in a variety of modes or ways using various mounting devices to facilitate deer feeding upon the log. Log 10 may also be hung by a wire, rope or the like, via hole 30 at a desired distance above the ground for feeding.

By way of example, and not by limitation, the following formulation may be used in providing the deer log 10. The example is for a batch of approximately three pounds, in order to provide logs of a larger size say six pounds in weight, the quantity of ingredients may be doubled. The ingredients for the three pound log are as follows: Soy Meal—24 oz.; Whole Corn—6 oz.; Cracked Corn—6 oz.; 82 Brick Liquid Molasses—7 oz.; Edible Tallow Binder—5 oz.; Ground Sweet Corn—⅜ oz.; Propionic Acid (an exemplary Preservative)—1.36 g.; and Attractant and Flavor selected from Agriflavor, Red Apple, Green Apple, Persimmon, Butter Kernel, Peanut Butter and Acorn—4-6 oz.

The foregoing ingredients are heated to approximately 150° F. and are mixed thoroughly and are compressed and formed under pressure as in a mold or form according to the desired log shape of body 11 with grooves 12 and 14, such as shown in FIGS. 1-5, the log is then allowed to cool and released from the mold. The logs may be formed into approximately 9 inch lengths to facilitate mounting. Other grains such as wheat, alfalfa, rice bran, sunflower seeds and dent corn may also be blended in, in addition to the ingredients mentioned above so as to provide different log mixtures. The binder may also be suet or gelatin.

Hole 30 is provided in body 11 of log 10 as part of the mold or form, or may made be made after log 10 is released from the mole, such as bored, drilled, or staked though body 11. Although hole 30 preferably extends through ends 10a and 10b of log 10, the hole may be made extend partially through body 11 from end 10a to a desired extent.

Variations and modifications in the herein described wildlife feeding block or log and the ingredients thereof and in the methods of fabricating the block, within the scope of the invention, will undoubtedly suggest themselves to those skilled in the art. Accordingly, the foregoing description should be taken as illustrative and not in a limiting sense.

What is claimed is:

1. A deer log comprising a generally cylindrical body of composite grains, meals and other materials, said body having a groove running longitudinally thereof, said groove having a cross-sectional shape compatible with the snout of a deer to be fed.

2. The deer log according to claim 1 wherein the cross-sectional shape is generally semi-cylindrical.

3. The deer log according to claim 2 further comprising a hole extending longitudinally through said body for accepting a stake, arrow or branch for mounting the log.

4. The deer log according to claim 1 further comprising a hole extending longitudinally through said body for accepting a stake, arrow or branch for mounting the log.

5. The deer log according to claim 1 wherein said groove represent one of a pair of grooves each compatible with the shape of the snout of the deer and extending lengthwise of the log and said pair of grooves are disposed diametrically opposite of each other.

6. A wildlife feeding block comprising a body of compressed materials having at least wildlife feed, and said body having an exterior surface with one or more grooves or channels that extend longitudinally along said body.

7. The wildlife feeding block according to claim 6 wherein said body is of a log shape.

8. The wildlife feeding block according to claim 6 wherein said body has two opposite ends, said one or more grooves or channels extend between said ends.

9. The wildlife feeding block according to claim 8 wherein said one or more grooves or channels are two in number and extend between said ends along opposite sides of said body.

10. The wildlife feeding block according to claim 9 wherein said grooves or channels mirror each other along said opposite sides of said body.

11. The wildlife feeding block according to claim 6 wherein said one or more grooves or channels has a concave cross-sectional shape compatible with a front of a deer snout.

12. The wildlife feeding block according to claim 6 wherein each of said one or more grooves or channels has a cross-sectional shape enabling full insertion of a front portion of a deer snout into the groove or channel.

13. The wildlife feeding block according to claim 6 further comprising a hole extending centrally through said body.

14. The wildlife feeding block according to claim 6 further comprising a hole extending at least partially through said body for use in mounting the block.

15. A method for providing a wildlife feeding block comprising the steps:
forming a log shaped body of compressed materials having at least wildlife feed; and
providing one or more grooves extending longitudinally along said body wherein each of said one or more grooves has a cross-sectional shape enabling insertion of a front portion of a deer snout to enable the deer to bite the log along the groove.

16. The method according to claim 15 wherein said providing step provides two of said grooves along opposite sides of said body.

17. The method according to claim 15 further comprising the step of providing a hole in said body for accepting a stake, arrow or branch for mounting the block.
